(19) United States
(12) Patent Application Publication
(10) Pub. No.: US 2011/0069379 A1
(43) Pub. Date: Mar. 24, 2011

(54) Microscope Configuration Determination

(76) Inventors: Klaus Becker, Breitenworbis (DE); Hakon Mikkelsen, Aldenhoven (DE); Peter Schnuell, Gleichen (DE); Alexander Scheps, Goettingen (DE); Matthias Kramer, Goettingen (DE)

(21) Appl. No.: 11/664,312

(22) PCT Filed: Sep. 22, 2005
(86) PCT No.: PCT/EP2005/010283

§ 371 Date: Feb. 14, 2008

(30) Foreign Application Priority Data
Sep. 30, 2004 (DE) 10 2004 048 099.0

(51) Int. Cl. G02B 21/24; G02B 7/16

(52) U.S. Cl. 359/368

(57) ABSTRACT

The invention relates to a lens or lens attachment component, which is designed to be mounted in a microscope and to which an electronic memory module (15) is fixed. Said component comprises two contact fields (16, 17; 18, 19) that are electrically connected to connections of the memory module (15), said fields permitting the memory module (15) to be electrically contacted and supplied with energy once the component is mounted.

Modern microscopes have a modular design, thereby enabling many different apparatus configurations. The apparatuses usually have exchangeable components, which influence the optical properties and, therefore, have to be selected to fit the desired microscopic method. Examples of such components are objectives held in revolving turrets, beam splitters or filters which can be incorporated to the apparatus by other revolving turrets or slides or can be built in separately. Components can be actuated, changed or adjusted both by a motor drive and manually. Particularly in the case of components which are manually or automatically changeable, the identification of the component presently active in the beam path is of great importance both for insuring that the correct configuration is set for a desired microscopic method and in order to provide correspondingly correct data for evaluation during microscopy.

An example of the problem that the configuration of a microscope has to be taken into consideration during use is found in U.S. Pat. No. 5,703,714, wherein manual input of the designations of all objectives provided in a revolving turret is possible. Suitable algorithms then take the parameters of the objectives into account during further microscopy. The input objective data are taken from conventional labels that have been attached to the objectives already since the early days.

It is further known in the prior art to carry out automatic objective recognition. For this purpose, U.S. Pat. No. 4,241,251 suggests to design objectives differently with respect to the thread length of the lens cone screwed into the revolving turret. Suitable detector means provided in the revolving turret thus allow to identify the objective currently rotated into the beam path and to thereby determine, for example, the magnification setting.

DE 102 45 170 A1 also discloses a mechanical approach for identification of an objective. Strip marks are provided on a changer magazine, said marks allowing to determine the position of the changer magazine by optical, electrical, magnetic or mechanical scanning of the strip pattern. This changer magazine may also be used for filters that can be rotated into position.

DE 100 55 534 A1 envisages the fixation of a wireless transponder, which may be provided, for example, in the form of an electronic label, to the objective as well as arranging a respective reading unit on the revolving turret, said reading unit wirelessly scanning the transponder of the objective which has just been rotated into position. Predetermined code information in the transponder allows not only identification of the type of objective, but in addition also allows access to data describing the objective and stored in the transponder.

DE 102 49 904 A1 extends the principle of the electronic label to the detection of other assemblies, for example optical filters. Incidentally, the use of electronic labels is also known from DE 100 10 140 A1 in connection with the identification of object slides. An electronic label of the type that could be used for this purpose, for example, is described in EP 0 715 760 B1 or EP 0 647 943 A1.

It is the object of the invention to provide means for simple and, if possible, universal recognition of components in a microscope.

According to the invention, this object is achieved by an optical component or an attachable optical component intended for incorporation into a microscope, to which component an electronic chip is fixed and on which two contact pads are provided which are electrically connected to terminals of the chip and by which the chip, with the component installed, is electrically contactable and can be supplied with energy.

It is also envisaged to identify the components in the microscope by an electrically contactable microchip. This enables detection of the presence of one or more components in the device simultaneously and automatically.

The wire-bound contacting of the chip on the optical component or on the attachable optical component according to the invention allows installation even in the case of limited space even for already developed structural elements. There is no need to reserve space for an antenna which is required in the case of an electronic label. Also, metallic bodies at or near the optical component or the attachable optical component, such as, for example, the metallic holder of a reflector module or beam splitter may not have negative effects on the communication with the chip. The wire bound contacting and energy supply of the module provided according to the invention, thus, prevents many problems which arise in connection with electronic labels, and, moreover, allows refitting of already existing or developed optical components.

According to the invention, the optical component is an optical part, which can be moved into the beam path of the microscope and influences the function of the microscope. Examples of such optical components include objectives, filter elements, beam splitters or the like. According to the invention, an attachable optical component is understood to be an attachment piece which can be attached to such optical component, for example a holder, a retainer ring, a retainer cap, a housing etc.

The chip is preferably a memory chip. In addition or as an alternative, a microchip comprising more than two electrodes can also be used, and may serve, for example, to measure time, temperature, pH value, current, electrical current or other physical quantities. It is also possible to effect, for example, temperature control by heating. If reference is made hereinafter to a memory chip, this is merely meant to be an example.

In order to allow optimum consideration of the configuration of the microscope during measurement, it is advantageous if the optical component or if an optical module equipped with the attachable optical component can be activated in the microscope depending on the operating condition. Advantageously, electrical contacting is effected for those optical components or those optical modules equipped with attachable optical components, which are activated in the microscope and are, for example, located in the beam path.

It is also possible, of course, to read out the chips of optical components or attachable optical components according to the invention manually, by means of a hand-held scanner, during incorporation into the microscope, so that the identification of the component just fitted can be effected in the control unit. For component recognition of components to be manually incorporated, use can be made of a hand-held scanner which is made to contact the contact pads of the optical component or the attachable optical component according to the invention, before or after the optical component or the optical part equipped with the attachable optical component is/has been installed in the microscope. An example of such a hand-held scanner is, e.g. the read/write interface VGL-S-RS 232 of Megatron Elektronik AG & Co., Hermann-Oberth-Strasse 7, 85640 Putzbrunn, Germany.

Moreover, data describing properties of the components may also be stored and accessed in the memory chip in addition to the data serving to identify components. Thus, for instance, serial numbers, specific protocols of measurement, such as optical spectra, deviations from predetermined specifications etc., can be stored, allowing statements about the optical component or about the optical part provided with the attachable optical component.

Conveniently, the electronic chip is as small as possible. An example of a module is the chip distributed Maxim, USA, under the name “1-wire”. It is connected via the two contact pads and both supplied with energy and read out. An example of the protocol used for reading out is the RS 232, RS 485, RS 422 or USB standard.

For small chips it is convenient to use a printed circuit board which, on the one hand, carries the chip and, on the other hand, provides the contact pads.

At least two contact pads are required for the chip to function. Said contact pads may be either parallel or coaxial. In a particularly advantageous embodiment, the printed circuit board comprises both parallel contact pads and coaxial contact pads, e.g. on opposite sides. Such printed circuit board comprising a memory chip may be used universally for the most diverse components. A size with a diameter of a circular printed circuit board of approximately 5 mm is achievable, thereby allowing the memory chip including the printed circuit board to be subsequently fitted into a simple blind hole of already existing components.

However, in many cases, it is not possible to drill such blind holes into objectives. In this case, it is convenient to use a ring as the attachable optical component, said ring carrying the electronic memory chip and being attachable to a sleeve of the objective.

The electronic chip can be attached in a particularly space-saving manner, if one of the two contact pads is formed by an (already existing) electrically conducting housing element of the component.

Depending on the design of the contact pads, a spring-loaded contact tip combined with a spring-loaded cylindrical contact, spring-loaded contact tips or sliding contacts arranged in parallel as well as soldered contacts are suitable for electromechanical contacting of the chip.

In a favorable embodiment for detection of components, the invention provides a microscope objective comprising an attachable optical component, which is provided as a ring attachable to an objective sleeve, one of the two contact pads being formed by the objective sleeve and the other one of the two contact pads being provided as a ring-shaped strip conductor. Such ring-shaped strip conductor can be contacted in a simple manner, allowing existing revolving turret constructions to be substantially maintained and requiring only little modification.

In principle, the optical components or the attachable optical components according to the invention allow identification or data acquisition to be effected for all optical parts present in a microscope, regardless of whether the optical parts for the microscope are presently active or not. If all optical parts which can be theoretically activated in a microscope are detected, it is convenient, however, to provide a detection mechanism determining which components in the beam path are presently active. This is where the approaches mentioned in the prior art are useful.

In a favorable embodiment only those optical parts which are active in the beam path or will soon be activated are read out with respect to their electronic chips. Therefore, it is convenient to provide a contacting mechanism for a microscope with recognition of components, said contacting mechanism being provided for incorporation into a microscope and for contacting the aforementioned optical component or attachable optical component according to the invention and contacting components that are or can be moved into the beam path of the microscope.

Particularly with respect to a changer mechanism, a situation may occur in some cases, where the element rotated into the beam path or activated in the beam path can not be contacted, for example, for reasons related to space, precision or stability. In such cases, it is convenient to effect contacting of the optical component or of the attachable optical component as long as it has not been moved into the beam path yet. Together with position detection for the changer unit, a control unit can then determine which optical component, or which optical part provided with an attachable optical component, is located in the beam path.

A similar approach is possible if it is of interest to know all available optical components or all available optical parts provided with attachable optical components, before using a microscope. If a changer unit is switched through all possible changing positions and the required data concerning the optical parts or optical components are respectively determined by contacting, such “reference operation” provides the necessary data on all available parts.

The contacting mechanism preferably effects active contacting of the optical component or the attachable optical component, i.e. it has a corresponding drive unit which establishes said contact. Of course, passive contacting, for example in the form of spring contacts, is also possible.

The number of contacting mechanisms usually corresponds to the number of modification locations at which the beam path of the microscope can be modified by changeable elements. The number of optical components or attachable optical components according to the invention is higher in most cases and usually corresponds to the number of optical parts which can be built in, i.e. optical components and parts provided with attachable optical components.

The contacting mechanism is used to transmit data from the electronic chip to a control unit of the microscope, which can effect a reading operation and, as the case may be, additionally also a writing operation. The electronic chip may comprise one or more data areas which can be password-protected, if necessary. This allows safe storage of a manufacturer's data, so that they can only be requested, for example, by the manufacturer's service personnel. The electronic memory chip is preferably well-protected against electrostatic voltages and charges. This is advantageous, in particular, in the case of manually changeable components, because changing them then be carried out without safety measures against electrostatic charges. The electronic memory chip advantageously preserves stored data for at least 10 to 20 years even if it is not supplied with a voltage at usual temperatures of between 0 and 85° Celcius.

The aforementioned object is further achieved by a microscope comprising a contacting mechanism of the aforementioned type and a control unit which is connected to the contacting mechanism via a communication link and, by scanning the chips, determines data concerning the configuration of the microscope. Although contacting of the chip is effected in a wire-bound manner according to the present invention, so as to realize the desired small structural dimension, it is still possible to realize the communication link between the control unit and the contacting mechanism also by radio. This allows to dispense with sometimes interfering cable connections in the microscope.

For detection and data acquisition with respect to the objective rotated into the beam path, a further embodiment of the microscope is convenient which comprises a revolving turret including an objective plate into which objectives can be inserted at objective eyes, said contacting mechanism comprising, for each objective eye, a plunger which contacts one of the two contact pads and one of the two connections of the chip.

It is favorable to provide one plunger for each objective, said plunger establishing the electrical contact upon insertion of the objective into the objective eye. If the objective uses the already described attachable optical component in the form of a retainer ring or a retainer cap, the rotary position of the microscope after incorporation at the objective plate is not important, because the plunger then merely has to contact the ring-shaped strip conductor. The contacting mechanism conveniently contacts only that plunger which is assigned to the objective rotated into the beam path. Thus, the plunger comprises a connector which is, for example, provided as a sliding ring or spring contact, arranged on the revolving turret such that it contacts the plunger of the objective rotated into the beam path.

With a view to as compact a construction as possible the other connection of the memory chip may be connected via a sliding contact contacting the objective sleeve when the attachable optical component connects said connection of the chip with the (conducting) objective sleeve in a conducting manner.

According to the invention, the aforementioned object is further achieved by a method of component detection in a microscope, wherein optical components and/or attachable optical components of the aforementioned type are used, the chip is electrically contacted and read out and the components presently active in the beam path of the microscope are determined from the read-out data. As already mentioned, this method can be carried out in a particularly simple manner if contacting is effected merely for those optical parts which are activated on the microscope, i.e. which are located in the beam path. The information on the determined components can be utilized during microscopy, in particular in correcting methods.

Finally, the aforementioned object is further achieved by a method for equipping a microscope in terms of detectability of components, wherein one or more optical component(s) and/or attachable optical component(s) of the aforementioned type or a microscope objective of the aforementioned type is/are built into the microscope and at least one contacting mechanism of the aforementioned type is provided on the microscope. In a simple manner, this method also allows to upgrade existing microscopes in terms of their ability to detect components.

By electrical contacting, the inventive solutions to the aforementioned problem allow not only a particularly small structural dimension, but also allow writing on the microchip at any time. The component detection made possible by the invention provides an operator with a better overview over the currently employed optical parts in the microscope. This allows to avoid faulty device settings or even inaccurate microscope images. At the same time remote control of the apparatus becomes more efficient and diagnosis of microscopes also becomes more efficient and more reliable. Finally, the component detection according to the invention also allows manufacture as well as the logistics on the part of the customer to be automated to a greater extent, in particular by providing serial numbers, article numbers and order number on the microchip, and this allows the control of manufacture as well as servicing to be structured more clearly.

The invention will be explained in more detail below, by way of example and with reference to the drawings, wherein:

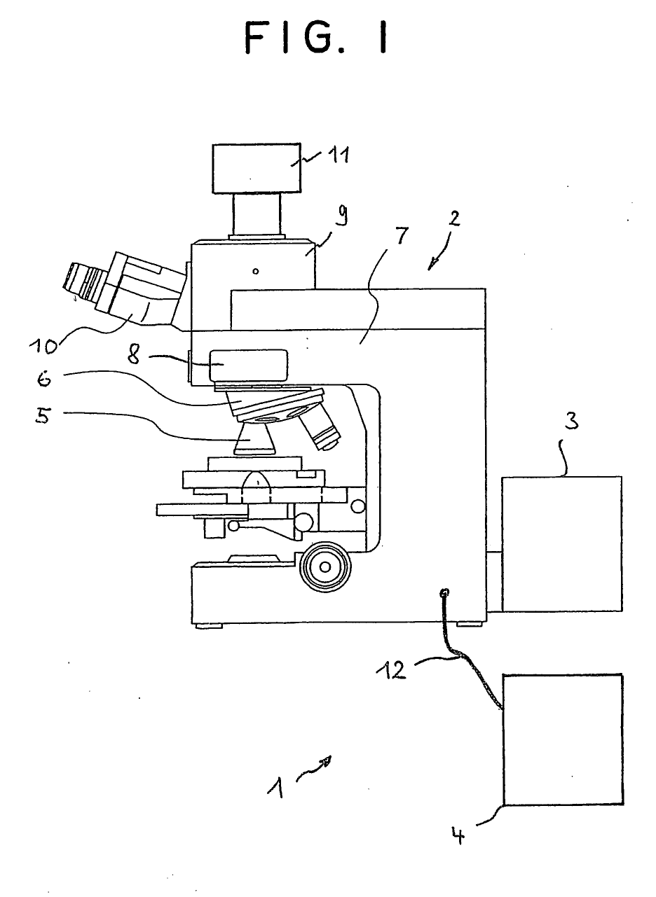

FIG. 1 shows a schematic representation of an optical microscope that can be configured in different ways;

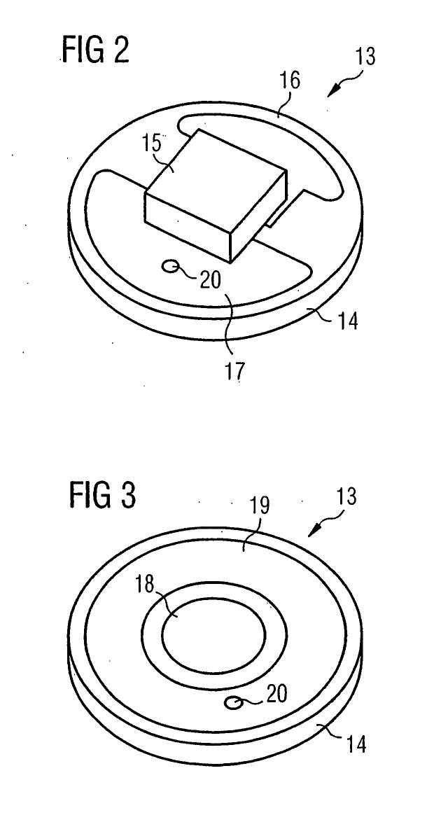

FIGS. 2 and 3 show perspective views of a module for component detection;

FIGS. 4 to 6 show perspective views of different optical components, each comprising the module of FIGS. 2 and 3;

FIGS. 7 and 8 show perspective representations of a contacting mechanism for the module of FIGS. 2 and 3;

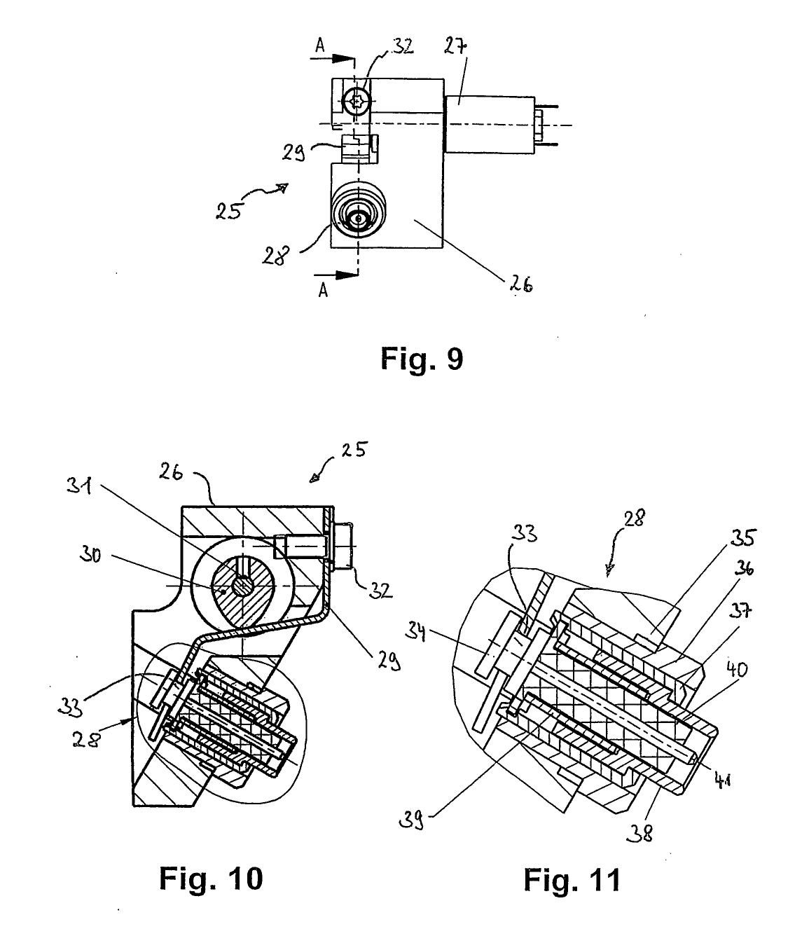

FIG. 9 shows a lateral view of the contacting mechanism of FIGS. 7 and 8;

FIGS. 10 and 11 show sectional views or partial sectional views of the mechanism of FIGS. 7 to 9;

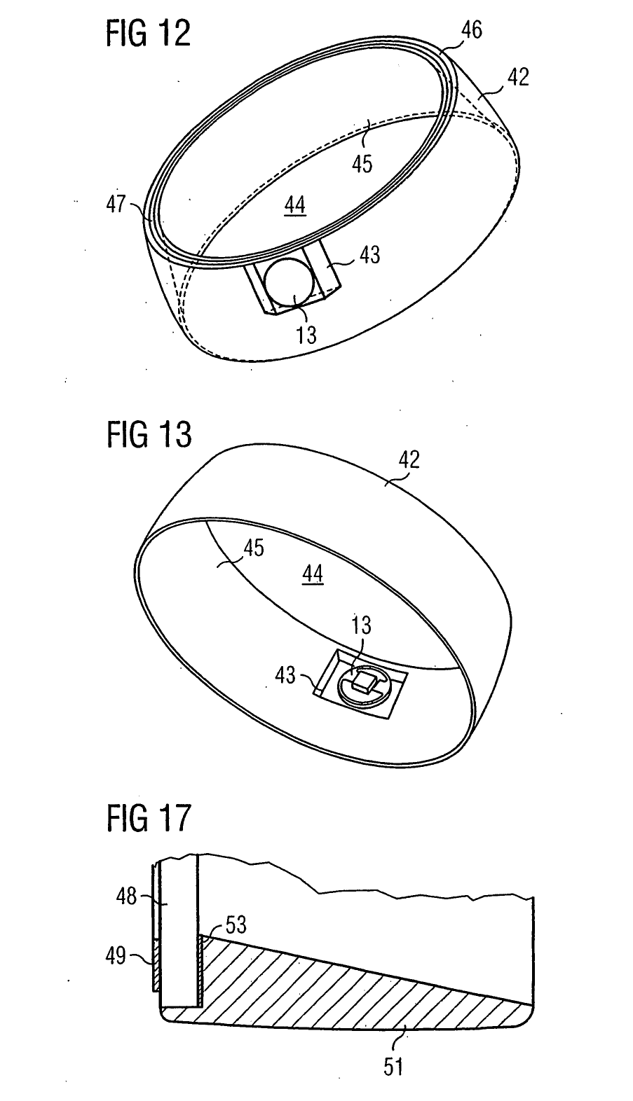

FIGS. 12 and 13 show perspective views of a retainer cap for a microscope comprising a module according to FIGS. 2 and 3;

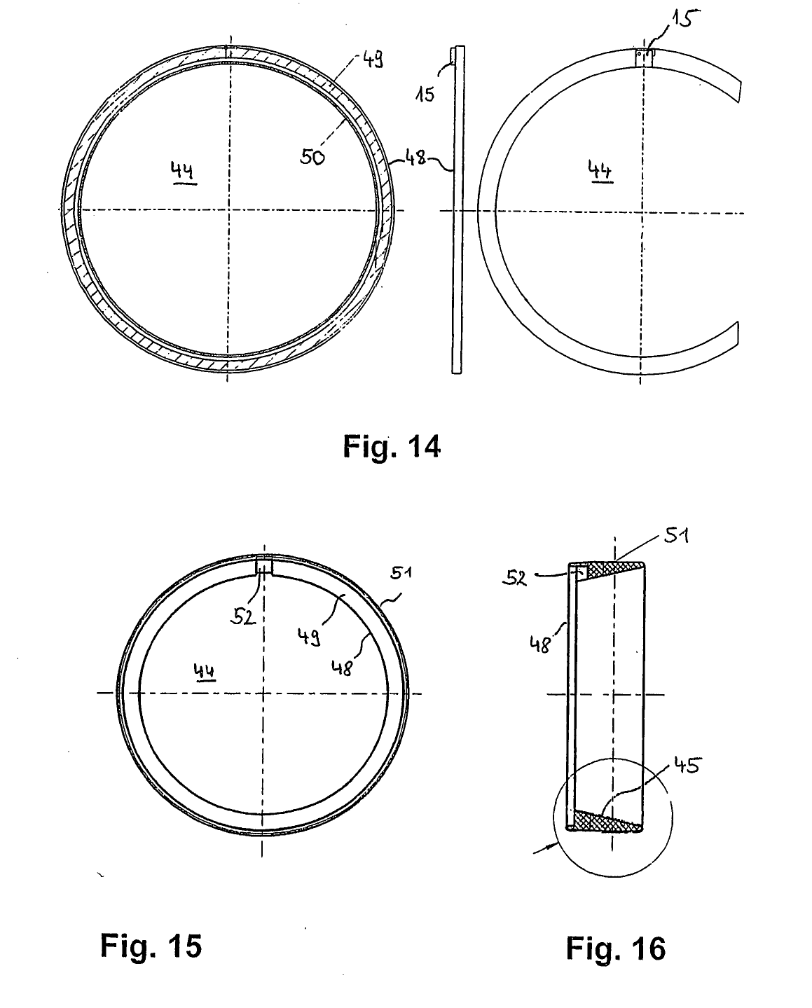

FIGS. 14 to 16 show top views of lateral or sectional views, respectively, of a retainer ring or a retainer cap similar to those shown in FIGS. 12 and 13;

FIG. 17 shows a detailed view of the structural part shown in FIG. 16;

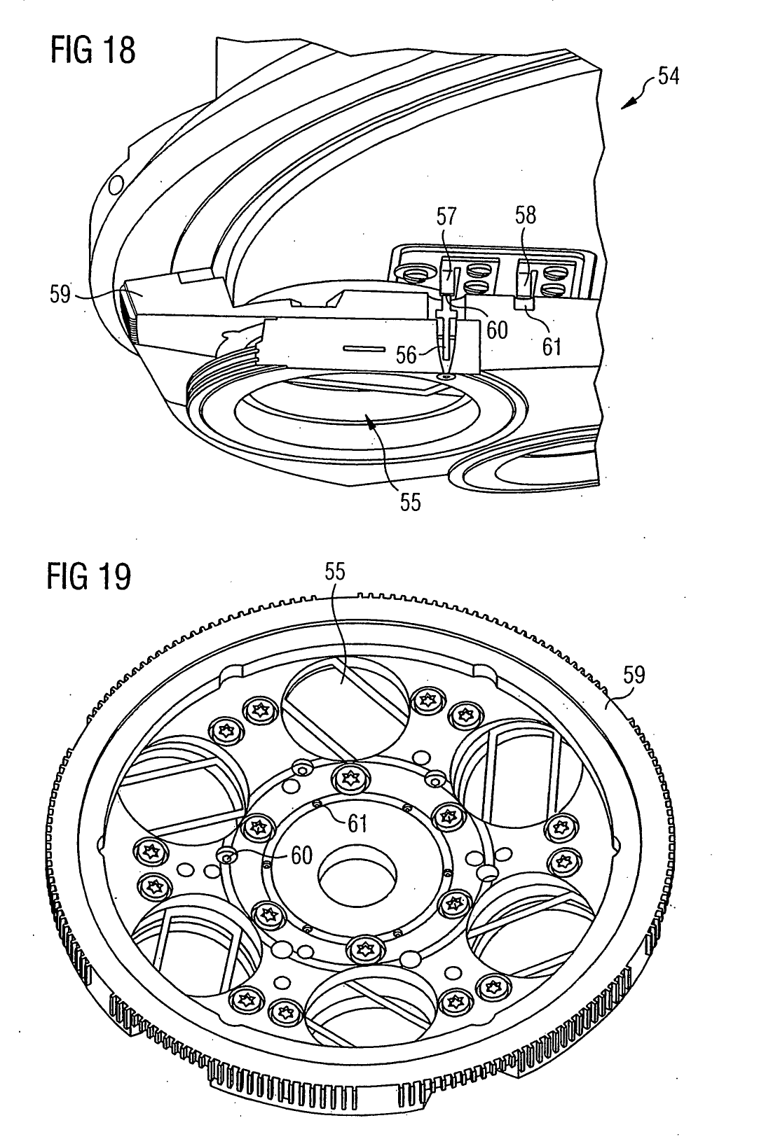

FIG. 18 shows a perspective view of a revolving turret for the microscope of FIG. 1;

FIG. 19 shows a perspective representation of a revolving turret of the objective plate used in FIG. 18, and

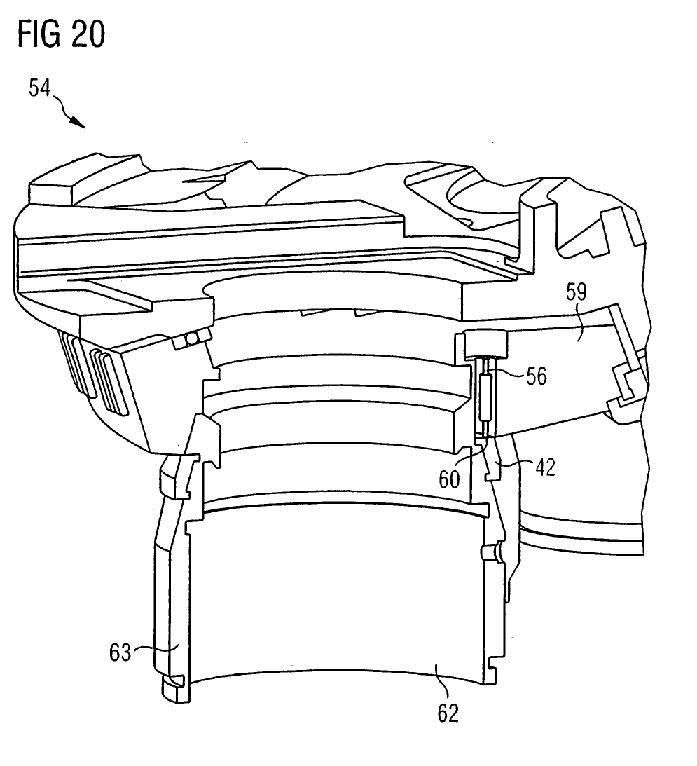

FIG. 20 shows a perspective view of the revolving turret of FIG. 8 with an objective inserted therein.

FIG. 1 shows a microscope system 1 which can be set up and used in different configurations. The re-configuration of the microscope system 1 can be effected both automatically, for example by a motor-driven change of components, and manually by intervention of an operator. In particular, the microscope system 1 comprises an optical microscope 2 which is attached to a light source unit 3 and which is controlled, during operation, by a control unit 4 comprising suitable input/output means. The input/output means may comprise, for example, a keyboard, a special input unit, a screen, data carriers, input systems (disc drive, CD drive or the like) or even a network connection.

Via an objective 6 the microscope 2 images an object arranged on the microscope stage. The objective 5 is mounted to a revolving turret 6, which is motor-driven in the embodiment example and allows different objectives to be rotated into position. A stand 7 of the microscope 2 is provided with a changer unit 8 at which different optical components can be inserted into the microscope 2. Said unit may be, for example, a revolving turret for reflectors, a filter or a beam splitter for conventional contrast methods (for example, DIC, TIC etc.). The image is then observed via a body tube 9 with an ocular 10 attached thereto or a camera 11 connected thereto. The detailed construction of the microscope 2 is of relevance to the following description only insofar as it may be configured in different ways by effecting a change or insertion or removal of optically active components.

The microscope 2 is connected to the already mentioned control unit 4 via a data link 12, said control unit 4 reading out control information regarding the operation of the microscope and feeding said information to the microscope 2, respectively. The degree of automation may be varied according to the variant realized. Intervention by the control unit 4 may include anything from a simple test of the microscope's function, to a warning concerning unfavorable configurations, a participation in image acquisition (for example, in laser scanning operation) or to a fully automatic microscope operation.

FIG. 2 shows a module 13 which is used for detecting optical parts fitted to the microscope system 2. The module 13 comprises a printed circuit board 14 on which a memory chip 15 is installed and is connected to two parallel contact pads 16 and 17 on the printed circuit board 14. The contact pads 16 and 17 allow contacting of the chip 15 which is provided for 2-point contacting. The contact pads 16 and 17 allow, on the one hand, for energy supply of the chip 15 and, on the other hand, for data communication with the chip. Said data communication takes place, for example, according to the USB standard. On the backside of the printed circuit board 14 shown in FIG. 3 there are located a central contact 18 as well as a ring contact 19 which are connected to the contact pads 16 and 17 by a suitable feedthrough. FIGS. 2 and 3 clearly show the feedthrough 20 for the ring contact. The feedthrough for the central contact is not shown in the drawings.

The chip 15 of the module 13 can thus be supplied with energy and read out or written on either by parallel contacting on the front side or by coaxial contacting on the backside of the printed circuit board 14.

The module 13 is generally employable and can be provided at almost any optical part of the microscope system 1 for component detection. Due to the possibility of a parallel as well as coaxial connection, flexible use is achieved; if one wishes to dispense therewith, it is possible, of course, to omit one of the two types of contact.

The module 13 is supplied with energy via the contacts, i.e. either the contact pads 16 and 17 or the central contact 18 including the ring contact 19, and is connected to the control unit 4 for data exchange. The control unit 4 can thus detect whether a module 13 is present in the microscope system 1. Due to a known assignment of the module 13 to an optical part of the microscope 1 component detection is thereby achieved.

As an alternative or in addition, there may be stored on the chip 15, in addition to a simple serial number which has to be assigned to an optical part via further external sources of information, also the information describing the optical part, for example, the name of said part, the product number, the specified values, the serial number, special protocols of measurement, such as spectra, deviations from specified values etc., up to characteristics required for compensations, for example temperature compensations. The data stored on the chip 15 are electrically read via the above-explained contacts. As already mentioned, the chip 15 may also perform other functions. In addition, a chip having further functions can also be provided, connected in parallel.

Data writing is conveniently effected by the manufacturer during installation of the module 13 into an optical part, but under certain circumstances it may also be effected on location, for example, if correction parameters are determined and are stored on the chip 15.

Upon a control command, the control unit 4 reads out the data of all modules 13 to which it has access, for example in a cyclic manner. Reading out is also possible if the control unit 4 detects a manual change in the microscope system 1 or if such change is indicated to it. This information provides the control unit 4 with a specific image of the present device configuration and the active components. Thus, the control unit 4 can warn an operator if an unfavorable configuration is present. In this respect, the disclosure of U.S. Pat. No. 5,703,714 is fully incorporated herein by reference.

In addition, after component detection has been effected, the control unit 4 can display the actual beam path of the microscope 2, for example on a monitor. By allocation of individual parameters of measurement stored on the chip 15, said parameters being those of the module 13 carrying the optical unit, the precision of measurement can be increased. Preferably, the exact balance length of an objective is thus considered by the control unit 4. The same applies to what is called the point spread function of an objective. Storage of these values in the control unit 4 as previously performed can be dispensed with, because the data are now available in the chip 15 and thus directly on the objective.

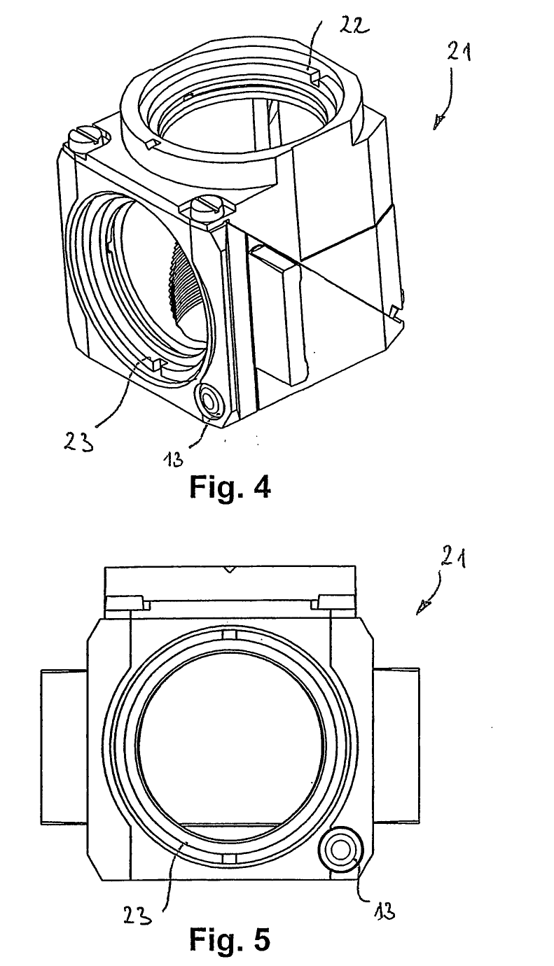

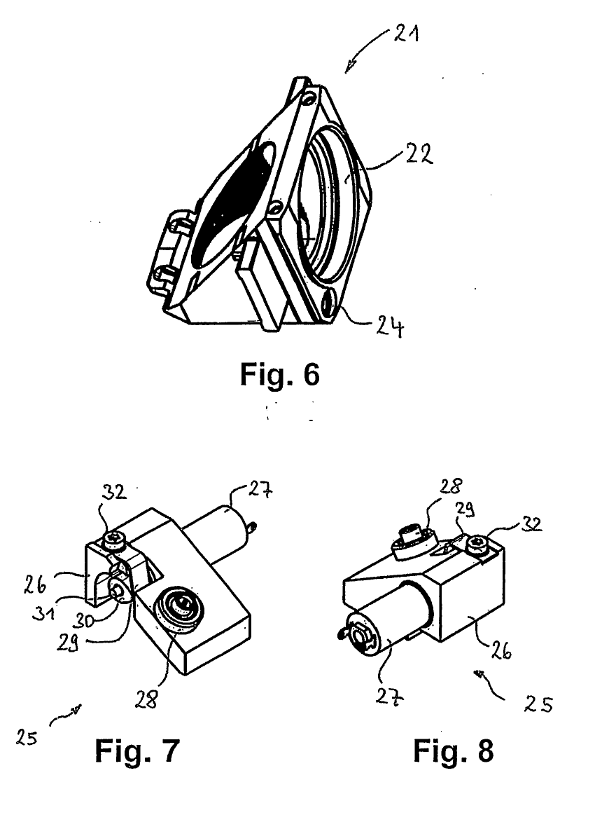

FIG. 4 shows the use of the module 13 on a reflector module 21, which carries further components that are connected to it via bayonet or screw connections 22, 23 and can be moved into the beam path of the microscope 1. One side of the reflector module 21 is provided with a blind hole into which the module 13 is glued. The view of FIGS. 4 and 5 shows that the backside of the printed circuit board 14 including the central contact 18 as well as the ring contact 19 is accessible. FIG. 6 shows an alternative design of a reflector module 21.

For component detection contact is established, in the embodiment according to FIGS. 4 to 6, by means of a separate hand-held scanner, such as already mentioned in the description of the advantages, prior to installing the reflector module 21 in the beam path of the microscope 2. Thus, prior to or following installation of the reflector module 21 in the microscope 2, the control unit 4 obtains access to the chip 15 of the module 13 and thus to the data describing or at least identifying the reflector module 21.

As an alternative or in addition to such manually assisted reading of data of the chip 15 when fitting a microscope system 2, fully automatic contacting of optical components is also possible. This is convenient, for example, in the case of optical parts which are often changed during operation using a changer mechanism as it is present, for example, in the form of the changing unit 8 in the microscope 2. An example thereof are reflector modules which can be changed via a revolving turret.

The contact sensor 25 shown in FIGS. 7 and 8 comprises a housing 26 to which an electric motor 27 is attached, which moves a contact pin unit 28. This contact pin unit 28 is fitted on the end of an arm 29 which is actuated by a cam 30 fitted on a shaft 31 that is driven by the electric motor 27. As the lateral view of FIG. 9 as well as the sectional view of FIG. 10 obtained along the line A-A of FIG. 9 show, a screw connection 32 fixes the arm 29 such that it is driven as a one-armed lever by the cam 30. At its free end, the arm 29 comprises an opening 33 in which a button 34 of the contact pin unit 28 is located. Rotation of the cam 30 displaces the bottom 34 along a longitudinal axis of the contact pin unit 28.

The contact pin unit 28 which is shown in FIG. 11 as an enlarged cutout of FIG. 10 comprises a sleeve 36 located in a wall 35 of the housing 26, in which sleeve an insert 37 is arranged so as to be longitudinally displaceable. The movement of the arm 29 starting at the button 34 displaces the insert 37 in the longitudinal direction within the sleeve 36. In the insert 37 a coaxial contact 38 is biased away externally from the button 34 by a spring 39. Since the button 34 is connected to the insert 37, the arm 29 also moves the coaxial contact 38 via the button 34. The same applies to a central contact 41 which is attached directly to the button 34 and is electrically insulated from the coaxial contact by an insulating piece 40.

The contact sensor 25 thus causes longitudinal displacement of the insert 37 by rotation of the cam 30. If the coaxial contact 38 is immobilized on a ring contact, the central contact 41 is displaced relative to the coaxial contact 38, because the coaxial contact 38 is moved into the insert 37 against the spring 39. This is effected until both the coaxial contact 38 and the central contact 41 contact the corresponding contacts of the printed circuit board 14.

The contact sensor 25 is preferably installed in the microscope 1 in all those locations where a changer unit for parts to be introduced to the beam path is provided. The control unit 4 communicates with the contact sensor 25 via the data line 12 as well as possibly, in addition or as an alternative, via radio links. The control unit 4 can thus obtain information on the configuration of the microscope system 1 at any time by activating the contact sensor 25 or, in the case of several sensors, by sequential or simultaneous activation and interrogation of all sensors, in that the contact sensor(s) 25 is/are actuated to read out the corresponding modules 13.

According to this concept it is advantageous, moreover, to provide additional means which detect the activity of a changer unit or generally the presence of an optical part. A possible example thereof is magnetic detection by means of Hall sensors. For example, a permanent magnet may be provided in a lid of the reflector module 21, said permanent magnet being read out by magnetic field sensors, for example a Hall sensor, mounted to the microscope 2. This sensor system, which can also use other types of sensors, of course, allows to recognize whether the lid of the reflector module is open or closed. Thus, the control unit 4 will know whether the lid of the reflector module 21 is open or closed, i.e. whether a reflector module is being changed or not. If a revolving turret for reflectors is provided, said turret will conveniently be rotated once to electronically read out all reflector modules, i.e. whether components were mounted thereto which may possibly require reading out. Such procedure is advantageous in particular whenever, in a changer mechanism, e.g. a revolving turret, the active element can not be measured (for example, due to reasons of structural dimensions) or should not be measured (e.g. in order to know the possible configuration in advance). In this case, the present assembly at the changer mechanism can be determined, stored and considered together with a position detection in a previous step.

The high storage capacity of the chip 15 is advantageous, because detailed information on parts, in particular the optical elements in the reflector module, can be obtained.

FIGS. 12 and 13 show alternative ways of arranging the module 13 in the form of annular sleeves 42 which can be slid over objectives. FIG. 12 shows a transparent plastic ring for mounting to the lens cone (for example by means of gluing) and comprising a recess 43 for receiving the module 13. The transparent design of the annular sleeve 42 avoids covering of any writing on the objective, when the annular sleeve 42 with its objective compartment 44 is slid over the objective. The module 13 is connected by its two contacts to two electric connections on the annular sleeve 42. A connection is formed by the internal surface 45 of the annular sleeve, which comprises electrical contact pads or establishes an electrical contact with an objective sleeve (not shown). The second contact is a ring-shaped conductor strip 47 provided at the upper edge 46 of the annular sleeve 42, the upper surface of said conductor being contacted when the objective is installed. A possible embodiment for this will be explained below.

The conductor 47 is circular, i.e. it is provided as a ring which fixes the objective with the annular sleeve 42 retained thereon usually by a rotary movement to the revolving turret. In case of mounting by a bayonet another solution would be possible, i.e. the conductor 47 would no longer be required to extend circumferentially with a circular shape.

FIG. 13 shows a similar construction of the annular sleeve 42, which is not transparent here, however. FIG. 13 clearly shows the position of the module 13 in the recess 43 of the annular sleeve. The non-transparent design of FIG. 13 has the advantage that an adhesive bond between the objective and the annular sleeve 42 can be effected in a simpler manner, because possible air bubbles are not visible. This makes mounting simpler and more affordable.

FIG. 14 shows a further possible construction of an attachable optical component which is in turn intended for attachment to an objective. In contrast to the annular sleeve 42 of FIGS. 12 and 13, a ring shaped circuit board 48 comprising two contact rings in the form of an external contact 49 and an internal contact 50 is provided here. The latter contact is intended, for example, for contacting an electrically conducting microscope housing provided in the objective's internal space 44. The ring shaped circuit board 48 carries the chip 15 on one side, said chip being connected to the external contact 49 or the internal contact 50, respectively, in an electrically conducting manner. Accordingly, said circuit board is an example of a construction which does not use the module 13 of FIGS. 2 and 3 but only uses the chip 15. The ring shaped circuit board 48 is attached to the objective by adhesive bonding. Connection is in turn effected by the metallically conducting housing and the external contact 49.

If no metallically conducting housing is present, contacting can be effected from outside, directly at the internal contact 50 and the external contact 49. This has the advantage of a double insulation, because the electrical potential of an objective housing is not affected. This results in advantages with respect to EMC or electrostatic protection.

As FIGS. 15 and 16 show, the ring-shaped circuit board 48, having a 2-part design, also allows to realize an annular sleeve similar to the variant shown in FIGS. 12 and 13. For this purpose, a sleeve 51 is used into which the ring-shaped circuit board 48 is inserted. A corresponding recess 52 provides space for the chip 15. The sleeve 51 can be connected directly to the internal contact 50 and in turn establishes the contact with an electrically conducting objective housing.

FIG. 17 schematically shows the detail indicated in a circle in FIG. 16 as well as a lower surface contact 53 of the ring-shaped circuit board 48, which is double-sided in this embodiment. Thus, in this construction the external contact 49 is arranged on one side and the internal contact 50 is arranged on the other side of the ring-shaped circuit board 48, which facilitates the electrical connection between the sleeve 51 and the ring-shaped circuit board 48.

In order to contact the objective, which may be equipped, for example, with the annular sleeve 42 of FIG. 12 or 13, a plunger 56 is provided on the revolving turret 54 in the region of each objective eye 55, said plunger being contacted via a spring contact 57. For this purpose, each plunger 56 has a plunger contact 60 on its upper surface. The plunger 56 with the plunger contact 60 as well as an additional mass contact ring 61 is provided in an objective plate 59 of the revolving turret 54.

FIG. 19 shows this objective plate 59. A plunger with a plunger contact 60 is located at each objective eye 55. Rotation of the objective plate 59 always moves that plunger contact 60 to the spring contact 57 which is assigned to the objective rotated into the beam path. This measure ensures that the chip 15 is read out for that particular objective which is presently rotated into the beam path. Of course, this may also realized differently, for example by reading out the position of the revolving turret.

FIG. 20 shows a perspective schematic view of the revolving turret 54 with inserted objective 62. The plunger 56 contacts the plunger contact 60 provided on the annular sleeve 52. The other terminal of the chip is established by the mass contact 28 (which is not shown in FIG. 20), which is connected to an objective sleeve 63 of the objective 64 and is in turn connected from the annular sleeve 62 to one of the terminals of the chip 15 (not shown in FIG. 20).

Of course, instead of the optical parts described here merely as an example, other elements having an effect on the beam path can be detected by using microchips 15 attached thereto for component detection. Examples include beam deflectors, color filters or gray filters, stops, aperture stops, field stop slides, DIC slides, TIC slides, cameras, capacitors, light sources, changeable revolving turrets, TV ports, body tubes, prisms, microtiter plates, object slides, electronic circuit boards controlling microscope components, or even the microscope stand.

1.-13. (canceled)

14. A component for fitting to a microscope, said component being one of an optical part and an attachment piece for an optical part, said component having an electronic chip mounted thereon and being provided with two contacts, which are electrically connected to terminals of the chip and via which the chip, with the component in place in the microscope, can be electrically contacted and supplied with energy, wherein energy supply as well as a data communication with the chip occurs via the two contacts and wherein the chip contains data serving to identify one of the component and the optical part attachable to the component.

15. The component as claimed in claim 14, wherein the component is an optical part or is attached to an optical part and said optical part can be activated in the microscope depending on the operating condition.

16. The component as claimed in claim 14, wherein the chip is mounted on a printed circuit board, which carries the contacts which is mounted to the component and which has at least two externally accessible contacts.

17. The component as claimed in claim 14, which is provided as a ring which can be mounted to an objective sleeve.

18. The component as claimed in claim 14, wherein one of the two contacts is formed by an electrically conducting housing element of the component.

19. The component as claimed in claim 14, wherein one of the two contacts is formed by an electrically conducting housing element of the component configured as a ring which can be mounted to an objective sleeve.

20. (canceled)

21. The component as claimed in claim 14, wherein the chip contains data describing the properties of one of the component and the optical part attachable to the component.

22. A microscope objective comprising a component as claimed in claim 19, wherein one of the two contacts is formed by the objective sleeve and another one of the two contacts is provided as a ring-shaped conductor strip.

23. A contact mechanism for a microscope with component detection, wherein the contact mechanism is provided for installation in a microscope and for contacting a component as claimed in claim 14, said contact mechanism adapted for contacting components which can be or have been moved into the beam path in the microscope.

24. A contact mechanism for a microscope with component detection, wherein the contact mechanism is provided for installation in a microscope and for contacting an objective as claimed in claim 22, said contact mechanism adapted for contacting components which can be or have been moved into the beam path in the microscope.

25. A microscope comprising a contact mechanism as claimed in claim 23 and a further control unit which is connected to the contact mechanism via a communication link and which, by scanning the chips, determines data on the configuration of the microscope.

26. A microscope comprising a contact mechanism as claimed in claim 24 and a further control unit which is connected to the contact mechanism via a communication link and which, by scanning the chips, determines data on the configuration of the microscope.

27. A microscope with an objective, the microscope comprising a contact mechanism with component detection, wherein the contact mechanism is for contacting the microscope objective, the microscope objective having an electronic chip mounted thereon and being provided with two contacts pads, one being formed by an objective sleeve and another one of the two contacts being a ring shaped conductor strip, the two contacts being electrically connected to terminals of the chip where with the objective in place, the chip can be electrically contacted and supplied with energy, the microscope further having a control unit which is connected to the contact mechanism via a communication link and which, by scanning the chips, determines data on the configuration of the microscope, the microscope further comprising a revolving turret including an objective plate into which objectives can be inserted at objective eyes, wherein the contact mechanism comprises a contact element for each objective eye, said contact element contacting one of the two contacts and, thus, connecting to one of the two terminals of the chip, wherein the chips contain data serving to identify the objectives.

28. A microscope comprising a contact mechanism with component detection, wherein the contact mechanism is for contacting a component comprising an optical part to the microscope, the component having an electronic chip mounted thereon and being provided with two contacts which are electrically connected to terminals of the chip where with the component in place, the chip can be electrically contacted and supplied with energy, the microscope further having a control unit which is connected to the contact mechanism via a communication link and which, by scanning the chips, determines data on the configuration of the microscope, the microscope further comprising a revolving turret including an objective plate into which objectives can be inserted at objective eyes, wherein the contact mechanism comprises a contact element for each objective eye, said contact element contacting one of the two contacts and, thus, connecting to one of the two terminals of the chip, wherein the chips contain data serving to identify the components comprising the optical parts.

29. A microscope with an objective, the microscope comprising a contact mechanism with component detection, wherein the contact mechanism is for contacting the microscope objective, the microscope objective having an electronic chip mounted thereon and being provided with two contacts, the two contacts pads are electrically connected to terminals of the chip where with the objective in place, the chip can be electrically contacted and supplied with energy, the microscope further having a control unit which is connected to the contact mechanism via a communication link and which, by scanning the chips, determines data on the configuration of the microscope, the microscope further comprising a revolving turret including an objective plate into which objectives can be inserted at objective eyes, wherein the contact mechanism comprises a contact element for each objective eye, said contact element contacting one of the two contacts and, thus, connecting to one of the two terminals of the chip, wherein the contact mechanism comprises a sliding contact at the objective plate, said sliding contact connecting the other one of the two terminals of the chip via the objective sleeve, wherein the chips contain data serving to identify the objective.

30. A method for component detection in a microscope, wherein components as claimed in claim 14 are used, the memory chip is electrically contacted and data read out therefrom and the components which are presently active in the beam path of the microscope are determined from the data read out.

31. A method for equipping a microscope for detecting components, wherein one or more component(s) as claimed in claim 14 is fitted to the microscope and at least one contact mechanism for contacting the component has contacting components which can be or have been moved into the beam path in the microscope.

32. A method for equipping a microscope for detecting components, wherein a microscope objective is fitted to the microscope and at least one contact mechanism is fitted to the microscope, wherein the objective has an objective sleeve and has a chip mounted therein, the chip contains data serving to identify the objective, wherein the objective has two contacts electrically connected to terminals of the chip, one of the two contacts is formed by the objective sleeve and another one of the two contacts is provided as a ring-shaped conductor strip.
